(19) United States
(12) Patent Application Publication
(10) Pub. No.: US 2004/0151197 A1
(43) Pub. Date: Aug. 5, 2004

(54) Priority queue architecture for supporting per flow queuing and multiple ports

(76) Inventor: Ronald Chi-Chun Hui, Hong Kong (HK)

Correspondence Address: SWIDLER BERLIN SHEREFF FRIEDMAN, LLP, 3000 K STREET, NW, BOX IP, WASHINGTON, DC, 20007, US

(21) Appl. No.: 10/687,827

(22) Filed: Oct. 20, 2003

Related U.S. Application Data
(60) Provisional application No. 60/419,527, filed on Oct. 21, 2002.

(51) Int. Cl. H04L 12/56

(52) U.S. Cl. 370/412; 370/395.4

(57) ABSTRACT

A shared memory switch architecture provides per-flow queuing that achieves high memory bandwidth and makes efficient use of memory. The memory of the memory switch is dynamically allocated to each port based on real-time traffic conditions. The priority of the packets is represented by queuing elements having a priority level determined by a weighted fair queue algorithm and its variants. The priority arbitration of queuing elements is made according to a two level hierarchy to increase the speed of priority queue management and therefore the switching throughput.

### CROSS REFERENCE TO RELATED APPLICATIONS

This application claim priority to prior provisional patent application No. 60/419,572 filed on Oct. 21, 2002 and entitled “Priority Queue Architecture For Supporting Per Flow Queuing And Multiple Ports.”

### FIELD OF THE INVENTION

The present invention relates generally to traffic management for packet based communications systems and, more particularly, to a traffic management system and method for providing per flow queuing to meet a guaranteed quality of service (QOS) for various network applications.

### BACKGROUND OF THE INVENTION

The advent of networked computers and continuous increases in bandwidth between networked computers has created a demand for new telecommunications services. Many of these services, such as video conferencing, television on demand, voice over internet protocol (VoIP), low delay enterprise applications and other real time data applications rely on quality of service (QoS) guarantees by network service providers in order to function properly. In other words, network providers have to allocate bandwidth properly among users such that each user's minimum QoS requirements are met. QoS may be characterized by a variety of factors including: the maximum packet delay; minimum bandwidth; and bounded packet loss rates. To properly implement QoS guarantees, network data traffic comprised of discrete packets must be properly managed.

Packets are fixed or variable sized packages of data that each have a header and a payload. The header associates the packet with a particular connection between a source and a destination computer. The payload represents the actual data for the connection. The network is comprised of switches, routers and other elements that carry packets from a source computer, through a series of interconnected switches or routers, to a destination computer. The switches and routers use the connection identifier within the packet header to route the packet properly between the source and destination nodes. Each switch includes input links and output links and switching fabric which is controlled to route data from the input links to the output links to perform the packet routing function.

In order to provide QoS guarantees, each switch or router must manage its packet traffic internally by prioritizing each packet received at its input ports and outputting each packet through its output ports toward its destination according to the packet's priority level relative to other packets received. Accordingly, a packet scheduler plays a crucial role for a switch. A typical commercial switch has 32 output ports and therefore a packet scheduler must be able to maintain several tens of priority queues simultaneously.

In the past, network providers have offered only 4 to 8 classes of service. Therefore, the switches in the network have associated the packets from thousands of users with one of the classes and guaranteed the minimum bandwidth for each class. This has severe shortcomings and is no longer adequate for guaranteeing quality of service. For example, while data flows for higher priority classes can be managed to be better than those of lower priority classes, data flows from within the same class contend for bandwidth among each other randomly. The network can only control the average delays of different classes but cannot guarantee the QoS of any particular user for revenue generating applications.

In order to guarantee QoS for individual users, it is necessary to provide per-flow QoS guarantees to ensure the QoS parameters of each user or application is met. A flow is a stream of packets corresponding to a particular user or revenue generating application and a given switch may manage 64,000, 256,000 or more individual flows. Individually managing QoS guarantees of each flow requires a great deal of complexity.

There are various techniques that may be used to provide per-flow QoS guarantees, including the weighted fair queuing (WFQ) method and its variants including the virtual clock algorithm. The weighted fair queue method uses reserved bandwidth and state information for each flow of packets to calculate a departure time for each new packet received for each flow. The departure time calculated for the new packet takes into account the time stamp of the previous packet received for the flow. The departure time is then used as an input to a scheduler which uses the departure time to select the highest priority packet for transmission from each output port.

However, a major problem associated with algorithms such as the WFQ algorithm is that size of the priority queue increases linearly with the number of flows. In addition, traditional priority queue algorithms have a log(F) time complexity for queue management, where F is the number of flows. As network link speeds increase exponentially with advances in fiber optic technologies like dense wavelength division multiplexing (DWDM), a switch/router has to process tens of millions of packets per second. Because of the intrinsic complexity of priority queue systems and the wire-speed packet processing requirement, it is very difficult to implement per flow queuing using the WFQ algorithm.

There are two types of switching architecture that may be used to perform traffic management in a switch a shared memory switch and a crossbar switch. A shared memory switch uses a shared memory buffer to store packets received at different input ports. The memory is accessed at discrete time slots determined by a memory access rate. At a particular time slot, an output port is allowed to read from the shared memory buffer to select and output packet data destined for that output port. However, if more than one packet is destined for the output port in the time slot and the port bandwidth will permit only one to be output, then output contention exists. When this occurs, an output scheduler is required to select the packet with the highest priority for transmission. A switch must maintain an individual priority queue for each output port to schedule the transmission of each packet properly.

A crossbar switch uses input buffers to store packets received from different inputs. The packets are then read from the input buffer some time later and switched to their destined outputs. To assist crossbar switching, each input buffer maintains N virtual output queues (VOQ). A switch has to maintain a priority queue for each VOQ so there are a total of N² queues on the input side.

It is desirable to use a shared memory switch architecture instead of a crossbar switch architecture because a shared memory switch can provide better QoS than cross bar switches at a lower cost. However, the switching capacity of a shared memory switch is limited by the memory access speed or memory bandwidth. The maximum switching capacity of conventional shared memory switches is around 20 Gbs. A crossbar switch capacity can scale to hundreds of gigabits or even terabit speeds but maintaining QoS guarantees is more complex.

Additionally, conventional shared memory switches have statically allocated a fixed amount of queue management memory to each output port. This gives rise to massive amounts of memory that largely go unused.

There is a need to provide a scheduling architecture that can provide per flow queuing for large numbers of flows that uses memory efficiently and dynamically among the output ports of the switch. There is a further need to provide a scheduling architecture with efficient algorithms for calculating the highest priority packet for each port to increase memory bandwidth and switching speed higher than conventional techniques. There is a further need for a scheduling architecture that may be implemented efficiently in a chip to provide a cost effective, high performance switching solution.

### SUMMARY OF THE INVENTION

According to the present invention, a shared memory switch architecture provides per-flow queuing with a high memory bandwidth and efficient use of memory. According to one embodiment of the invention, the memory of the priority queue is dynamically allocated to each port based on real-time traffic conditions. The priority of the packets is represented by queuing elements having a priority level determined by a weighted fair queue algorithm and its variants. According to another embodiment of the invention, the priority arbitration of queuing elements is made according to a two level hierarchy to increase the speed of priority queue management and therefore the switching throughput.

According to one embodiment of the present invention, a memory switched switching apparatus includes a memory queue, row min logic, global min logic and a scheduler. The memory queue has addresses corresponding to individual flows and stores queuing elements at each address. New queuing elements correspond to new packets received by the switch for routing, given a priority level and enter the memory queue upon receipt. The rowmin logic determines the highest priority queuing element for each port on each row upon receipt of each new queuing element. The global min logic is coupled to the rowmin logic and identifies the highest priority queuing element for each port upon the receipt of each new queuing element. The scheduler is coupled to the global min logic and dequeues the packets for each port by outputting the packet associated with the highest priority queuing element for each port identified by the global min logic.

According to one embodiment of the invention, the queuing memory has row that each store queuing elements for more than one output port. The rowmin logic may include a filtering element for excluding from the highest priority level determination queuing elements associated with other ports. Alternatively, each row may store queuing element for only one output port. The queuing element may include a pointer to a linked list of other queuing elements for the flow. In addition, each queuing element may include a valid flag which is set to valid for a packet in the queue and changed to invalid after the queuing element is dequeued.

According to another embodiment of the present invention, a method of scheduling packets within a memory switched architecture is provided. According to the method, a shared priority queue is maintained that stores queuing elements associated with multiple flows and multiple output ports. A priority level is determined for a newly arriving packet based on its flow identification and a priority level of the previous queuing entry for the flow. The new queuing element is stored in the priority queue based on its flow identification and includes its determined priority level.

The shared priority queue may include rows comprising multiple columns for storing multiple queuing elements. In addition, each queuing element may include an output port identifier specifying an output port for its corresponding packet.

The method may further include determining whether the new queuing element has the highest level of priority for the same output port on its row and for determining whether the new queuing element has the highest level of priority among all of the queuing elements in the priority queue for the same output port. The method may further include selecting an output port for dequeuing and outputting to the switching matrix the flow identifier and priority level corresponding highest priority queuing element for the selected port.

According to another embodiment of the present invention, the priority queue architecture according to the present invention may be used to implement input and output line cards in a crossbar switch architecture.

### BRIEF DESCRIPTION OF THE FIGURES

The above described features and advantages of the present invention will be more fully appreciated with reference to the accompanying detailed description and drawings in which:

FIG. 1 depicts an architecture for providing per flow packet queuing according to an embodiment of the present invention.

FIG. 2A depicts a functional block diagram of a packet scheduler having a shared priority queue according to an embodiment of the present invention.

FIG. 2B depicts a queuing entry according to an embodiment of the present invention.

FIG. 2C depicts a configuration of the shared priority queue according to an embodiment of the present invention.

FIG. 3A depicts a dequeuing unit according to an embodiment of the present invention.

FIG. 3B depicts a dequeuing unit according to another embodiment of the present invention.

FIG. 4 depicts a method of enqueuing a newly arriving packet according to an embodiment of the present invention.

FIG. 5 depicts a method of dequeuing the highest priority packets for each output port from the shared priority queue.

FIG. 6 depicts a functional block diagram of a cross bar switch.

FIG. 7 depicts a functional block diagram of a shared memory switch which may be implemented as the shared memory switch within a shared memory switch or router or as a shared memory switch within the input ports or output ports in a crossbar switch.

FIG. 8 depicts a functional block diagram illustrating a two level hierarchy for implementing priority queue arbitration according to an embodiment of the present invention.

### DETAILED DESCRIPTION

Shared Memory Switch Architecture and Methods

According to the present invention, a shared memory switching architecture and method provide per-flow queuing of packets, high memory bandwidth and efficient use of memory. According to one embodiment of the invention, a shared priority queue within the memory is dynamically allocated to queuing elements for different ports based on real-time traffic conditions. The queuing elements each represent a flow and each have a priority level determined by a weighted fair queue algorithm. According to another embodiment of the invention, the highest priority queue elements for each port are determined and dequeued according to a two level hierarchy to increase the speed of memory priority determinations and therefore the switching throughput of the architecture.

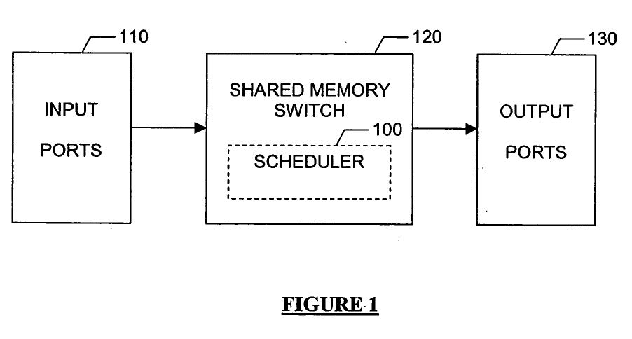

FIG. 1 depicts a functional block diagram depicting the architecture of a switch or router. Referring to FIG. 1, the switch includes a plurality of input ports 110, output ports 130, switching fabric and packet memory 120 and a packet scheduler 100. The switching architecture and packet memory operate under control of the packet scheduler and routes packets received from the input ports through the appropriate output ports toward the destination node for the packet. The packet header determines which output port the switch will place the packet on.

The packet scheduler 100 is used to enforce the quality of service (QoS) parameters of the switch. In particular, the packet scheduler provides per-flow queuing according to a weighted fair queue algorithm and its variants. In addition, the packet scheduler incorporates a shared memory queue which is shared among all of the output ports. The shared priority queue memory, describe in more detail below, permits the dynamic allocation of queuing elements to output ports of the switch. Accordingly, the amount of memory devoted to queuing element for each output port changes dynamically with changing network conditions. This is different from conventional output port priority queues which include one output queue per output port having a static allocation of a fixed amount of memory to use for packet scheduling.

The conventional approach wastes a large amount of memory because packet traffic flows on networks such as the Internet conditions are constantly changing. Therefore, the memory for each output port is statically allocated to support a small number of queues, such as per-class queuing. However, using per-flow queuing and under most traffic conditions, most of the priority queues of each output port will be only partially full while others may be overflowing.

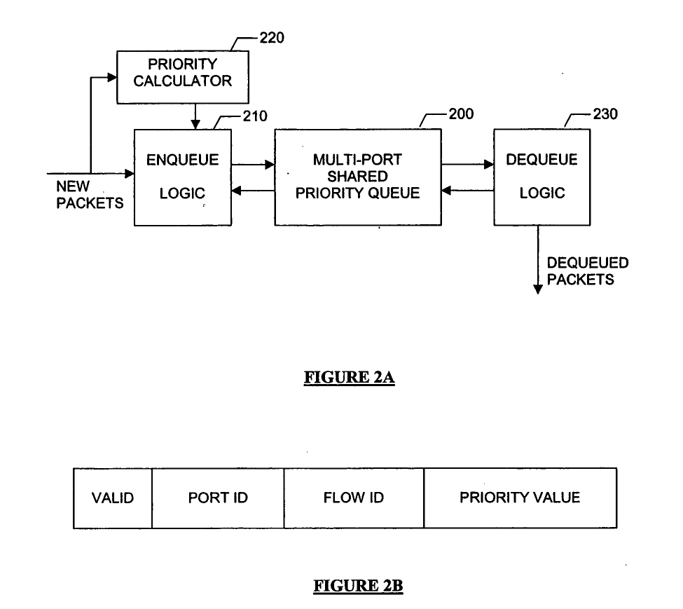

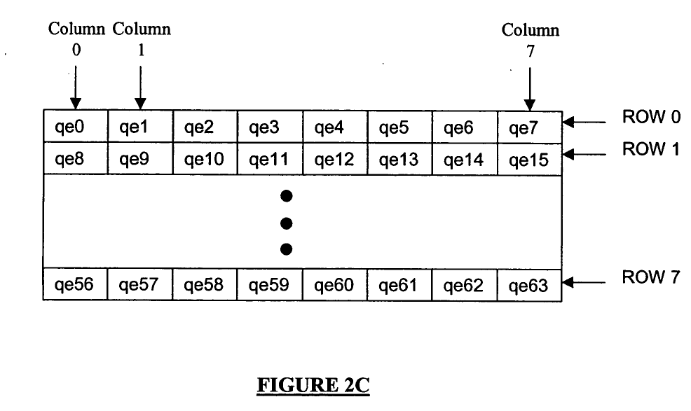

FIG. 2 depicts a packet scheduler according to an embodiment of the present invention which incorporates a scheduler that can allocate queuing management memory to multiple queues. Referring to FIG. 2, the packet scheduler includes enqueue logic 210, a priority calculator 220, a multi-port shared priority queue 200 and dequeue logic 230. The enqueue logic is coupled to the switching fabric 120 and the priority calculator 220 and the multi-port shared priority queue.

The enqueue logic 120 receives packet data from the switching fabric 120 (or an input port) when a new packet arrives over an input port at the switch. The enqueue logic then creates a queuing element based on information relating to the new packet. The queuing logic is given a flow identifier which relates the packet to one of the flows being managed by the packet scheduler. The flow identifier is either given to the enqueue logic by a packet classifier which determines the flow identifier based on connection information found in the packet header that identifies the connection that the packet belongs to.

The connection information may take various forms and may comprise more than a single part. For example, the connection information may include a virtual path identifier (VPI) and a virtual connection identifier (VCI) for an asynchronous transfer mode (ATM) cell. In other schemes, such as the Internet protocol, the connection information is derived by a combination of multiple packet headers. Depending on information that the priority calculation requires, the switching fabric may provide this information to enqueuing logic. The additional information might include the packet length, internal priority information, the time stamp of arrival of the packet or other useful information.

The enqueue logic creates a queuing element that represents each newly arrived packet. An illustrative queuing element is depicted in FIG. 2B. The queuing element includes the determined flow identifier and a priority level that is determined by the priority calculator 220 according to a weighted fair queuing algorithm and its variants. The queuing element also includes an output port identifier that denotes the destined output port from which the newly arrived packet will leave in the future. The queuing element also includes a valid bit which is set to valid until all packets associated with the flow leave the switch. After the queuing element is dequeued, its valid bit is set to invalid to reflect that the queuing element no longer represents an unrouted packet within the switch. The rest of the queuing element is retained, however, until it is written over.

The priority calculator 220 implements any kind of flow priority calculation. For purposes of this description, the weighted fair queuing algorithm and its variants, such as the virtual clock algorithm, is illustrative set forth as an example. It will be understood, however, that any algorithm for calculating priority may be used in the priority calculator. The virtual clock algorithm determines a priority value based on the priority value (VC) of the previous packet and the packet length according to the following equation: VC_{new}=Max {VC_{old}, current_time}+(V_{tick}*new_packet_length).

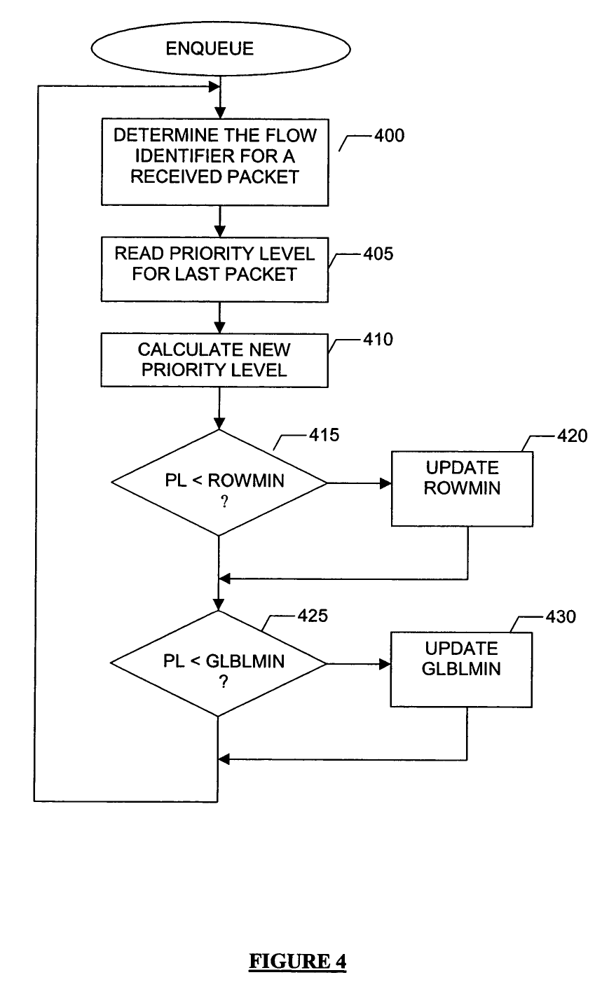

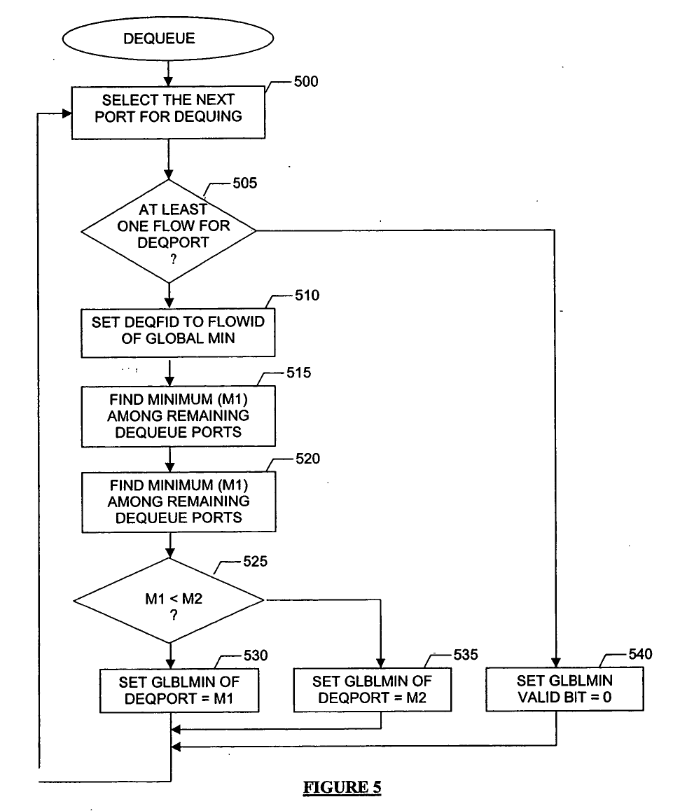

According to one embodiment of the invention, the priority value of the old packet is determined as shown in the method flow diagram of FIG. 4. Referring to FIG. 4, in step 400, the flow identifier of a newly arriving packet identifies a queuing element location within the shared priority queue memory 200 corresponding to the flow. In step 405, the queuing element location within the shared memory 200 is read to specify the VC_{old} of the last packet in the series for the flow which is used in the above calculation. The VC_{old} in this scenario is the priority level corresponding to the last packet that arrived for the flow.

In step 410, the priority value of the new queuing element is determined and the queuing element is written into the shared memory at the location associated with the flow identifier. When the queuing element at the memory location identified by the flow identifier has a valid bit set to invalid, the new queuing element overwrites it. When the queuing element at the memory location identified by the flow identifier has a valid bit set to valid, the new queuing element is not enqueued. During the enqueue process, a first in first out (FIFO) controller finds an available buffer space for the newly arrived packet.

In step 415, the enqueue logic determines whether the priority value, in this case a virtual clock value, is less than the lowest priority value within the row of memory that includes the queuing element. If the new priority value associated with a particular output port is lower than the other priority values of the row for the same port, then step 420 begins, otherwise step 425 begins. In step 420, the queuing element is stored as the rowmin value in a separate row min data structure. Alternatively, each queuing element may include a rowmin bit which, when set, indicates that that particular queuing element has the highest priority value for the particular port for the row.

In step 425, the enqueuing logic determines whether the priority level of the newly arrived queuing element has a higher priority than the highest global priority level, referred to as global min in the context of this application, for the same output port. If so then in step 430, the global min value is updated with the flow identifier and priority value of the newly arrived queuing element. The global min values may be stored in a data structure separate from the priority queue. Alternatively, a global min bit within each queuing element may be set to indicate when it is the global min for a given port. After steps 425 and 430, the process enqueuing process begins again in step 400 with the next newly arrived packet. In this manner, the rowmin and global min values are kept current to reflect the highest priority packets at all times. This facilitates the process of dequeuing the highest priority packets for each output port because the packets priorities are continuously kept current with the arrival of each new packet.

The newly written queuing element may include all of the information identified in FIG. 2B. However, the flow identifier may be omitted according to some embodiments of the invention because its value may be implied by the location within the shared memory associated with each flow.

The shared priority queue 200 may comprise a dual port random access memory (RAM) for high performance operation. According to one embodiment of the invention, the priority queue may be described as memory with R rows of C queuing elements each. Therefore, the memory itself may have a memory width of C * the queuing element width and a depth of R. An illustrative arrangement is shown in FIG. 2C.

Referring to FIG. 2C, the queuing elements may be arranged so that each row has multiple queuing elements that are each addressable by row and column addresses. For a R×C shared priority queue, the row address generally includes r=log₂ R bits. The column address generally includes c=log₂ C bits. According to one embodiment of the invention, the flow identifier of each flow is correlated with a row and column address so that the flow identifier determines the row and column location for the queuing elements for the flow. The correlation may be done in any convenient manner including by making the most significant bits of the flow identifier the row address and the least significant bits of the flow identifier the column address for the priority queue. Any convenient scheme may be used, however.

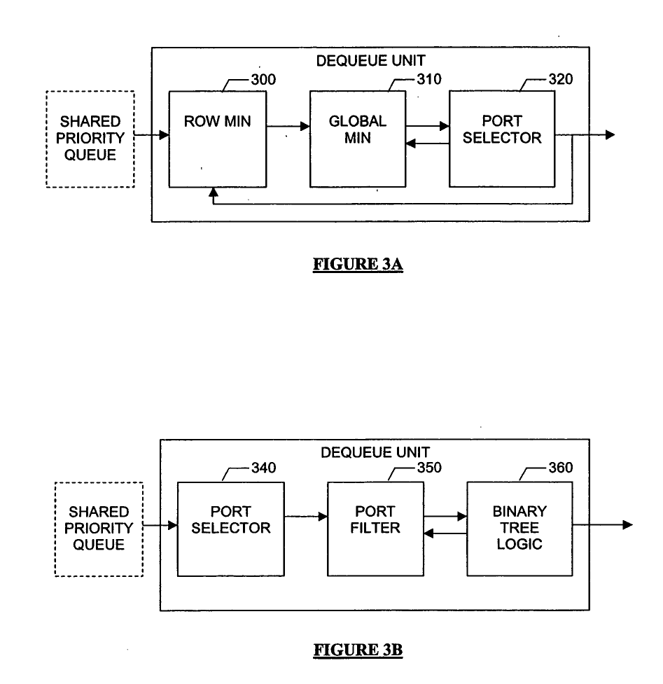

Each location within the priority queue 200 includes the most current, valid queuing element or the last, invalid queuing element. The dequeue logic 230 generally continuously cycles through the output ports of the switch. It then reads the shared priority queue for each port and dequeues the highest priority queuing element for each port. The dequeuing process may be done in many different ways, two of which are illustratively described below relative to FIGS. 3A and 3B.

The dequeue logic changes the status of the queuing element within the shared priority queue to invalid. Alternatively, the dequeue logic may overwrite the queuing element with the queuing element having the next highest priority for the flow. In this manner, the priority queue is immediately updated to reflect the routing of the last packet.

FIG. 3A depicts dequeue logic 230 according to a preferred embodiment of the present invention. Referring to FIG. 3A, the dequeue logic includes a row min unit 300, a global min unit 310 and a port selector. The row min unit 300 and the global min unit 310 together establish a two level hierarchy for dequeing the highest priority queuing element for each output port. The port selector controls which port is being dequeued at any given time. The port selector may cycle through the output ports sequentially or may dequeue two or more ports simultaneously depending on the complexity of the dequeue logic.

The rowmin and global min values are kept current as a result of the enqueue process of the enqueue logic according to the method of FIG. 4. In this manner, the row min unit determines and stores the highest priority queuing element for each port within each row at all times after a queuing element is dequeued. The global min unit includes logic that determines the highest priority queuing element for each port based on the row min values. The global min logic may be implemented as a binary tree or using any other convenient approach.

FIG. 5 depicts the dequeue logic according to an embodiment of the present invention. Referring to FIG. 5, in step 500, the dequeue logic receives the port to be dequeued. This port, identified as a deqport, may be identified by logic external to the scheduler or the switch, or by the output port or other location depending on how the shared memory switch is implemented. In step 505, the dequeue logic determines if at least one active flow for the dequeue port exists. If no, then step 540 begins. If there is, then step 510 begins. In step 510, the identification of the flow for the packet to be dequeued is identified based on the flowid of the global min value for the selected dequeue port.

In step 515, the dequeue logic finds the minimum (m1) row min value among the remaining rows of the shared priority queue. The rowmin of the dequeued row is set to m1. In step 520, the dequeue logic finds the minimum (m2) among remaining queuing elements on the dequeued row. In step 525, the dequeue logic determines whether m1<m2. If so, then step 530 begins. If not, then step 535 begins.

In step 530 the global min of the dequeued port is set to the queuing element specified by m1. This queuing element is then dequeued by sending the flow id of the dequeued element to the switching fabric. The valid bit may also set to invalid in the shared memory.

In step 535 the global min of the dequeued port is set to the queuing element specified by m2. This queuing element is then dequeued by sending the flow id of the dequed element to the switching fabric. The valid bit may also set to invalid in the shared memory.

In step 540, there are no flows to dequeue for the output port selected. Accordingly, no dequeing is performed and the method begins again with the next output port.

As an alternative to the dequeing structure shown and described relative to FIG. 3A, FIG. 3B may be used. Referring to FIG. 3B, the dequeing unit includes a port selector 340 a port filter 350 and binary tree logic 360. The port selector selects the port for dequeuing. The port selector then provides an input to the port filter 350. The port filter 350 receives all of the queuing elements from the shared priority queue and filters out the elements that are destined for a port that is not selected. It also filters out invalid queuing elements. With respect to the remaining queuing elements which include valid data destined for the selected port, the priority level of each queuing element passes through the binary tree of comparators resulting in, at the end, an output of the queuing element with the highest priority level for the selected port. The queuing element output from the binary tree becomes the dequeued queuing element and its flow identifier is outputted. In addition, the binary tree logic updates the shared priority queue to change the valid bit of the dequeued element to invalid.

Cross Bar Switches and Shared Memory Switch Implementation

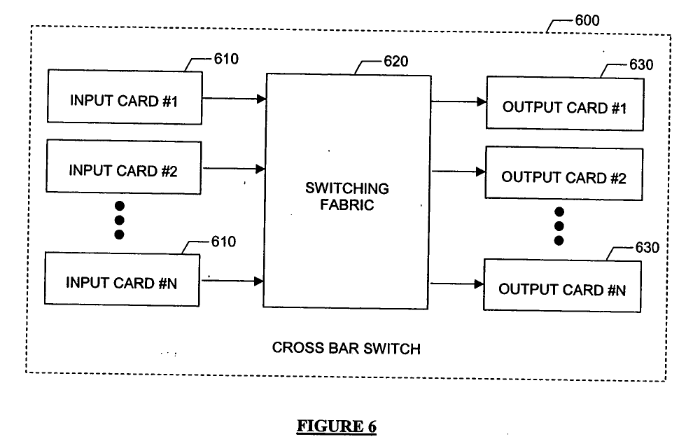

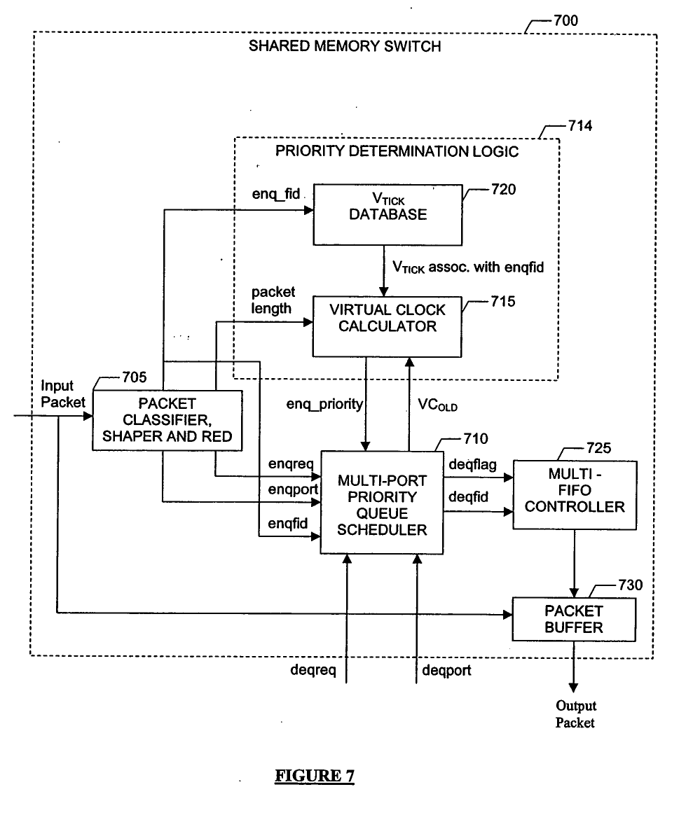

FIG. 6 depicts a high-capacity crossbar switch 600 according to an embodiment of the present invention. Referring to FIG. 6, the switch 600 includes a plurality of input cards 610 coupled to switching fabric 620 which is in turn coupled to output cards 630. The switching fabric operates by connecting at most N inputs to N outputs at any given time, where N varies depending on the performance of the switch 600. However, there is no port contention associated with the switching fabric. Therefore, only one output is connected to one input and only one input is connected to one output. The switching fabric may be implemented by cross bar technology, clos network technology or any other technology.

During operation, the switching fabric may cause one or more input cards to send a packet to a particular output card and may cause one or more outputs to receive a packet. Each input line card 610 and output line card 630 may be configured to operate as a shared memory switch according to one embodiment of the present invention. The shared memory switch of each input line card causes the input line card to queue received packets into a priority queue associated with different output ports and output the queued packets to the switching fabric according to a scheduling determined in part by the scheduling algorithm used.

FIG. 7 depicts a shared memory switch 700 according to an embodiment of the present invention. The shared memory switch may be implemented within the input line cards 610 and output line cards 630 of a cross bar memory switch. In addition, the shared memory switch may be used to implement a high performance shared memory switch itself that interconnects input and output links as shown and described relative to FIGS. 1-5.

Referring to FIG. 7, the shared memory switch 700 includes a packet classifier, shaper and RED 705, a multi-port priority queue scheduler 710, a virtual clock calculator 715, a Vtick database 720, a multi-FIFO controller 725 and a packet buffer 730. The packet classifier 705 receives an input packet and extracts packet header from incoming packets and, based on the packet headers, determines the flow identifier for each input packet. For ATM type packets, a simple table lookup is performed to find the flow identifier corresponding to the output VCI and VPI. For IP packets, multiple packet headers from layer 1 to layer 7 are compared with the policy database. The packet headers may match multiple rules in which case the highest priority rule is selected and the associated action performed. Other traffic management operations, such as traffic shaping and random early drop (RED) policing are also carried out to drop the input packets if necessary. The input packets may come from input links, ports of switching fabric or other internal nodes depending on where the shared memory switch is implemented. Moreover, the new packet may come from a buffer or FIFO memory which buffers incoming packets that are waiting for priority enqueuing. The buffering may be performed in multiple buffers or FIFOs based on the individual flows to which each waiting packet corresponds.

If the packet shaper 705 does not drop the inputted packet, the shaper will forward certain information from the new input packet to the priority determination logic 714 and to the priority queue scheduler 710 for processing. This information may include, for example, an enqueue request signal (enqreq), an enqueue port signal (enqport) and an enqueue flow identifier signal (enqueue fid). The enqreq signal is a request to enqueue the new packet, or put the packet in the priority queue scheduler for handling and routing according to its level of priority. The enqport signal specifies the output port number that the newly arrived packet is destined for. The output port information is determined by the packet classifier 705 based on the packet header. The enqfid, determined by the packet classifier 705, specifies the flow identifier of the flow occupied by the input packet.

The packet classifier 705 also transmits to the priority determination logic 714 the enqfid and the packet length. Additional information from the packet header may be transmitted to the priority logic to be used as an input for determining the priority level of the packet. FIG. 7 depicts the priority logic as being implemented with the virtual clock algorithm. Accordingly, the priority logic includes a Vtick database 720 and a virtual clock calculator 715. The Vtick calculator determines the Vtick associated with the packet flow identified by the enqfid. The Vtick then becomes an input to the virtual clock calculator 715.

The virtual clock calculator 715 receives the old virtual clock value corresponding to the enqfid for the new packet from the multi-port priority queue scheduler 710. The virtual clock calculator then determines and outputs the enqueue priority (enq_priority) to the priority queue scheduler 710 for the scheduler 710 to store as part of a new queuing entry that represents the newly input packet. The enq_priority may represent any type of priority value, including those where a higher value means higher priority and those where a lower value means higher priority, such as with the virtual clock algorithm.

The priority queue scheduler 710 operates as described relative to FIGS. 1-5. It performs two basic functions: 1) it enqueues each newly arriving packet destined for each port and 2) when an output port requests to send a packet, the priority queue outputs the highest priority among all of the queuing elements destined for that port. As such, the priority queue scheduler 710 creates new queuing entries for newly arrived packets based on the enqreq, enqport, enqfid and enq_priority signals and stores them into its queue. The priority queue scheduler 710 also dequeues queuing entries based on the deqreq and deqport signals which may be received from logic internal to the switch or external to the switch. The deqport signal identifies the next output port to which or from which to dispatch a packet. The deqreq signal is a dequeue request signal that requests that the highest priority packet be dequeued for the port identified as the deqport. The logic that generates deqreq and deqport signals may take into account real time traffic conditions on the network affecting the throughput and availability of the output links and output ports of the switch.

Based on the deqreq signal and the deqport signal, the priority queue scheduler 710 dispatches to the multi-FIFO controller two signals. The deqfid signal is a signal that provides the flow identifier for the packet to be dequeued to the FIFO controller 725. The deqflag signal, indicates to the multi-FIFO controller 725 when it should use the deqfid signal to identify an address of the packet to dequeue and output.

The multi-FIFO controller outputs the packet address within the packet buffer 730 corresponding to the next packet in the flow identified by the deqfid signal when the deqflag is set. The packet buffer 730 receives the packet buffer address signal, identifies the selected packet based on the signal, and outputs the selected packet.

The output packet is then transmitted to the appropriate place depending on where the shared memory switch is implemented. When the shared memory switch is implemented as a switch or as an output buffer, the output packet is transmitted out of an outbound link from the switch. When the shared memory switch is implemented as an input line card, the output packet is transmitted to the switching fabric for transmission to the appropriate output line card.

The scheduling system according to the present invention may be implemented as part of an integrated circuit chip such as a field programmable gate array (FPGA), an application specific integrated circuit (ASIC) or any other type of chip. In addition, while the weighted fair queuing algorithm has been described as a method for determining the priority level of the queuing elements, other algorithms may be used.

Priority Arbitration as a Two Level Hierarchy

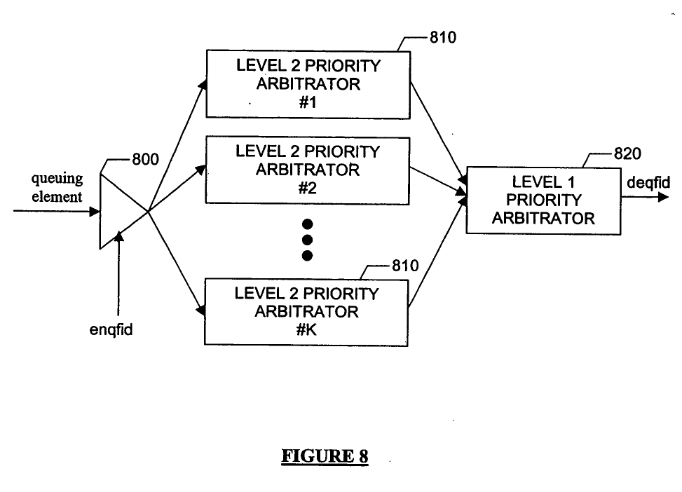

FIG. 8 depicts a functional block diagram showing a two level hierarchy for enqueuing and dequeing queuing elements to accomplish scheduling according to one embodiment of the present invention. Referring to FIG. 8, there is one level 1 priority arbitrator 820 and a plurality of level 2 priority arbitrators 810. The level 2 priority arbitrators 810 may be, for example, the rows of the queuing memory shown in FIG. 2C and the rowmin logic 300 that determines the highest priority queuing element for each port of each row. Each level 2 priority arbitrator 810 maintains priority queues for a subset of queuing elements. Each queuing element is processed by only one of the level 2 arbitrators. The level 1 priority arbitrator 820 may be, for example, the globalmin logic 310 which determines the highest priority element for each port based on the highest priority rowmin values for each row.

During an enqueue operation, the selector 800 directs the enqueue information for a newly arrived packet to one of the level 2 arbitrators responsible for handling the new queuing element. During a dequeue operation, each level 2 arbitrator outputs the highest priority queuing element stored in it and sends it to the level one priority arbitrator. The level 2 arbitrators only output information for the highest priority queuing element for the selected port.

The level 1 arbitrator selects the queuing element with the highest priority identified by the level 2 arbitrators. The level 1 priority arbitrator must be able to handle the same number of queues as output ports. The level 2 priority arbitrators may handle separate queues up to the number of output ports. According to one embodiment of the present invention, queuing elements of each level 2 priority arbitrator are assigned to only one output port so that each level 2 priority arbitrator may employ methods directed to handling one priority queue such as the well known heap algorithm. To reduce the dequeue time, the level 2 priority arbitrator outputs the highest priority value as soon as the dequeue command is issues. According to other embodiments of the present invention, each level 2 priority arbitrator stores queuing elements destined for one or more different output ports.

Since a queuing element may be associated with any one of the N output ports or deqports, there may be at most N rowmin values for a row and the total number of rowmin values in a priority queue system according to one embodiment of the invention may be N*R where R is the number of rows or the number of level 2 priority arbitrators.

To support finding the highest priority of the remaining rowmin values for the dequeue operation, the scheduler may access all of the rowmin values attributed to the different rows for the dequeue port d in parallel as shown in FIG. 8. Then, the scheduler may output different rowmin values into a comparator circuit to find the minimum one among them. Therefore, the rowmin storage may be implemented as a memory with a width of N * the entry width of the row min value and a depth of R. If the number of rowmins for different ports for each row are constrained to a certain value, such as T, then a smaller amount of memory may be devoted to storing rowmin values. Instead of allocating N rowmin entries for each row, the priority queue system only needs to have T rowmin entries for each row. Therefore, the rowmin memory is reduced to a width of T * the entry width of the row min value and a depth of R. This may be desirable to reduce memory demands. T may range from 1 to N depending on the application.

While particular embodiments of the present invention have been described, it will be understood by those having ordinary skill in the art that changes may be made to those embodiments without departing from the spirit and scope of the present invention.

What is claimed is:

1. A memory switched switching apparatus comprising:
a memory queue for storing queuing elements, the memory having addresses that identify the flow_id of individual flows;
rowmin logic coupled to the memory for determining the highest priority queuing element for each row;
global min logic coupled to the rowmin logic for identifying the highest priority queuing element for each port; and
a scheduler coupled to the global min logic, the scheduler dequeuing the packets for each port by outputting the packet associated with the highest priority queuing element for each port identified by the global min logic.

2. The memory according to claim 1, wherein each row stores queuing elements for more than one output port.

3. The memory according to claim 3, wherein the row min logic includes a filtering element for excluding from the highest priority level determination for each port within each row the priority level of queuing elements associated with other ports.

4. The memory according to claim 1, wherein each row stores queuing elements for only one output port.

5. The memory according to claim 1, wherein each queuing element includes a pointer to a linked list of other queuing elements for the flow.

6. The memory according to claim 6, wherein each queuing element includes a valid flag which is set to valid when the queuing element stores a priority level of a packet in the queue and set to invalid after the queuing element is dequeued.

7. The memory according to claim 7, wherein the dequeued queuing element is replaced by the queuing element corresponding to the next packet in the flow after a dequeue operation.

8. A method of scheduling packets within a memory switched architecture, comprising:
maintaining a shared priority queue having queuing elements associated with multiple flows and multiple output ports;
determining a priority level for a newly arriving packet based on its flow identification and a priority level of a queuing entry in the priority queue corresponding to the flow identification; and
storing a new queuing element corresponding to the newly arriving packet in the priority queue based on its flow identification, the new queuing element including its determined priority level.

9. The method according to claim 8, wherein the shared priority queue includes rows comprising multiple columns for storing multiple queuing elements.

10. The method according to claim 9, wherein each queuing element stores an output port identifier specifying an output port for its corresponding packet.

11. The method according to claim 10, further comprising determining whether the new queuing element has the highest level of priority for the same output port.

12. The method according to claim 11, further comprising updating a rowmin value when the new queuing element has the highest level of priority for the same output port on a row.

13. The method according to claim 12, further comprising determining whether the new queuing element has the highest level of priority among all of the queuing elements in the priority queue for the same output port.

14. The method according to claim 13, further comprising updating a globalmin value when the new queuing element has the highest level of priority for the same output port within the priority queue.

15. The method according to claim 14, further comprising selecting an output port for dequeuing and outputting to the switching matrix the flow identifier and priority level corresponding to the global min value for the selected port.

16. The method according to claim 15, further comprising:
outputting a packet from the selected output port based on the flow identifier corresponding to the global min value for the selected port.
